(19) United States
(12) Patent Application Publication
(10) Pub. No.: US 2025/0184412 A1
(43) Pub. Date: Jun. 5, 2025

(54) ROUTING PACKETS WITH FAILED LABEL LOOKUP

(71) Applicant: Arista Networks, Inc., Santa Clara, CA (US)

(72) Inventors: Rajan Keshari, Bengaluru (IN); Anil Joshi, Bengaluru (IN); Basil Saji, Bangalore (IN)

(73) Assignee: Arista Networks, Inc., Santa Clara, CA (US)

(21) Appl. No.: 18/525,171

(22) Filed: Nov. 30, 2023

(51) Int. Cl. H04L 69/22; H04L 45/50

(52) U.S. Cl. CPC H04L 69/22; H04L 45/50

(57) ABSTRACT

A networking device receives packets that may include a label header specifying a label for processing the packet based on a corresponding entry in a label table. When the label has a corresponding entry in the label table, the packet is processed according to the label entry. When the packet has a label but the label table does not have a corresponding label, rather than discarding the packet, the networking device converts the packet for forwarding according to a network address specified in the packet. Label headers may be removed from the packet to prevent subsequent devices from incorrectly continuing label-based processing, enabling the packet to “exit” the overall path represented by the labels and processed as though the packet didn't arrive with a label header. When devices may lack intended labels, this permits continued processing of packets according to the network address information.

### BACKGROUND

This disclosure relates generally to label-based networking and more particularly to reducing data loss when a networking device receives a packet specifying a label that does not have a corresponding entry in a forwarding table.

Networking devices route packets within a network with various methods according to the packet headers and available routing information of the networking device. Various types of packet headers signify different ways for handling information for routing the packet. The different headers may then be processed with different pipelines of the networking device. In some cases, specific paths in the network may be assigned labels (such as Multi-Protocol Label Switching (MPLS) labels), such that ingress packets to the networking device having a label are automatically processed according to the label. The label typically represents a decision to handle the packet in a specific way and according to the specific path of the associated label, enabling efficient handling by the networking device when the labels are configured. When a packet is received with a label for label-based forwarding, the label controls its processing, such that the label is looked up in a label table and forwarded according to the forwarding information in the label table. When the label is not present in the label table, the packet is typically discarded because the label typically represents a specific “intended” flow for packets having the label, and because the packet is labeled for delivery according to the specific path that is unknown to the networking device.

### BRIEF DESCRIPTION OF THE DRAWINGS

FIG. 1 shows an example environment in which networking devices transfer information between devices, according to one embodiment.

FIG. 2 shows example components of a networking device, according to one embodiment.

FIG. 3 shows an example of packet processing that may be applied by a packet processor, according to one embodiment.

FIGS. 4 and 5A-B show an example of label-based processing with backup address-based processing, according to one embodiment.

The figures depict various embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION

### Overview

Rather than automatically discarding the packets with unknown forwarding label, the networking device instead attempts to convert the packet for delivery according to its destination address (e.g., an IP destination address), if such an address is available in a subsequent header. When a packet's label is not present in the label table, the additional headers in the packet are examined to determine whether the packet can be delivered according to a destination address. When the packet includes a header with a destination address, the packet is instead processed for delivery based on the destination address, for example converting the label-based forwarding of the packet to an IP-based forwarding of the packet. Because the label may represent a specific “path” (or sequence of paths) for the packet, converting the packet's handling to an address-based forwarding discards the previously-intended path, such that any remaining label-based headers may be removed from the packet to prevent future networking devices from unintended further processing according to a label path that was not followed by the current device. Converting the label-based forwarding to an address-based (e.g., based on IP addresses) forwarding allows potential delivery of a packet to its intended destination when the packet includes both a label and a destination address. This allows the address-based forwarding to become a fallback despite the packet label and may prevent dropped packets when networking devices, particularly intermediate nodes in the network, may not yet have current information about labels applied at earlier parts of the network.

### System Environment

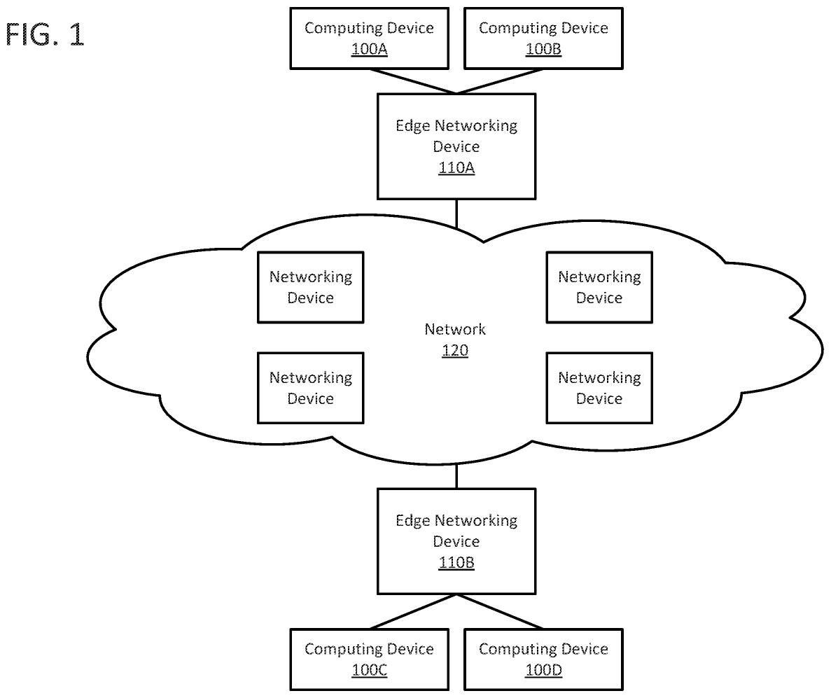

FIG. 1 shows an example environment in which networking devices transfer information between devices to reach a destination, according to one embodiment. In the environment of FIG. 1, computing devices 100A-D may communicate to one another via networking devices in a network 120 accessed via associated edge networking devices 110A-B. The networking devices and related processes discussed herein may also be applied to different networking configurations and architectures, such that the particular arrangement shown in FIG. 1 shows one example architecture in which these approaches may be applied. For example, the networking architecture may include communication across disparate datacenters, spine-and-leaf architectures (e.g., within a datacenter), communication across the Internet, and other types of configurations. In general, the networking devices, such as those shown in network 120 and the edge networking devices 110A-B, provide various network switching and routing services between various computing devices and may provide networking services with L2 and/or L3 network addressing (e.g., including handling with Media Access Control (MAC) and Internet Protocol (IP) addresses).

The different computing devices 100 may communicate with packets including a payload for delivery and header information describing various information for handling processing of the packet during network communication. The headers may include various types of information, including information about the type of data, source, destination, sequence information, priority information, virtual private network (VPN) membership, labels, and so forth. The networking devices use the headers to determine the handling of each packet, and in the process may add, modify, remove, and otherwise change the set of headers for a packet.

The various networking devices may apply different types of approaches for forwarding a packet towards its final destination (e.g., from computing device 100B to computing device 100D). The particular routing approaches vary in different embodiments and in different configurations, and may include determining routes in conjunction with other networking devices, including broadcasting information about desired destinations and configuring routes in conjunction with other devices. One type of routing uses packet labels to automatically process the packet according to a corresponding rule for the label, such that the specific processing for the packet may be “pre-determined” for the packet and enable rapid packet processing according to the label. One such approach for label-based processing is Multi-Protocol Label Switching (MPLS).

One or more label headers may be added to a packet to begin label-based processing for a packet, enabling processing of the label headers at intermediate networking devices (until the “end” of the label-based path). As each networking device may use the label(s) to process the packet, the sequence of networking devices related to a particular label (or related labels) and the handling across the network may represent a specific circuit or set of paths for the packet to travel across a portion of the network related to the labels. That is, a label may be added at one networking device representing the “start” of a “circuit” related to the label, and subsequent networking devices may process the packet according to the label until a networking device at the end of the “circuit” terminates the label-based processing. Such label-based processing may thus require coordination across different networking devices and be based on defined paths between portions of the network.

Packets may be routed with different protocols at different points of the network. For example, an initial header from the computing device 100 originating the packet may describe a recipient device according to a destination address, such as an IP address. An edge networking device 110 receiving the packet may initially route the packet to a subsequent device based on the destination networking address. The subsequent device may process the packet by pushing one or more labels onto the packet based on the destination address, such that further devices process the packet based on the label(s).

Although the labels typically represent a particular circuit or desired path for a packet, there may be instances where a networking device receives a packet having a label header that is not defined for that particular networking device. For example, a networking device between the addition of a label and completion of the label-based circuit in the network may receive a packet having the label and not have the defined rule for processing that label. This may occur when information about the label has not yet been received by a particular networking device to configure the rules for processing the label. As examples, this may happen when the network is reconfigured, the networking device is recently reset, a label expires, and so forth. As discussed more fully below, rather than discarding the packet because the networking device cannot comply with whatever processing was intended for the specified label, the networking device reverts to handling of the packet according to other addressing information available in subsequent headers of the packet. Although the labels typically represent a specific circuit or other processing to be applied to the packet, transitioning the packet to an address-based processing (e.g., with an L3 address such as an Internet Protocol (IP) address) enables further processing of the packet and possible delivery. Although the delivery may differ from the “intended” processing of the packet (according to the intended processing of the label(s)), the packet may be alternatively delivered to its intended destination.

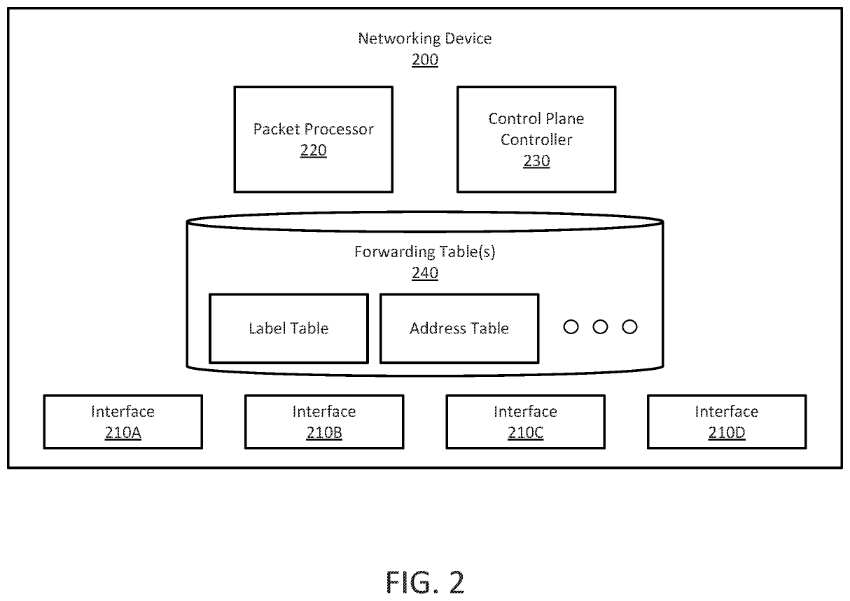

FIG. 2 shows example components of a networking device 200, according to one embodiment. The networking device 200 may be implementations of the networking devices shown in FIG. 1, such as the networking devices within the network 120 or the edge networking devices 110A-B. The various components shown in FIG. 2 are generally discussed with respect to their functional behavior, such that various implementations may separate the discussed functionality into additional components, or further combine the functionality to fewer components than discussed herein. In addition, in many instances, the discussed components are implemented in hardware circuits, registers, memories, processing circuits, and so forth, and thus may include application-specific circuits, programmable circuits, as well as general-purpose processors (that operate on instructions in a memory, such as a non-transitory computer-readable medium) for performing the discussed functions.

The networking device 200 includes a number of interfaces 210A-D for receiving and sending packets. Packets received at an interface 210 may be stored during processing at a packet buffer (not shown) and processed by a packet processor 220 for processing and routing determinations with subsequent egress of the packet at one of the physical interfaces 210, which is typically a different physical interface 210 than the physical interface at which the packet was received. In some embodiments, received packets may also be filtered at the physical interface 210A-D or by another component (such as a packet processor 220), for example, to retain packets that are addressed to the networking device 200, and discard packets that are not addressed to the networking device 200. This filtering may be based, for example, on hardware-level addresses (i.e., link layer addresses), such as a Media Access Control (MAC) address associated with the networking device 200 or its physical interfaces 210A-D.

The packet processor 220 processes received packets according to information in a forwarding table 240. The forwarding table 240 may be instantiated as one or more memories, registers, or tables holding the relevant information for determining one or more forwarding parameters describing how the packet processor 220 will handle the packet. Such forwarding parameters may include specifying one of the interfaces 210A-D for egress of the packet along with information for modifying the packet before egressing the packet. As a simple example, the forwarding parameters for a particular packet may specify interface 210B for egress along with a destination MAC address for the nexthop device (i.e., the immediately subsequent device) to modify the respective MAC address in the packet header.

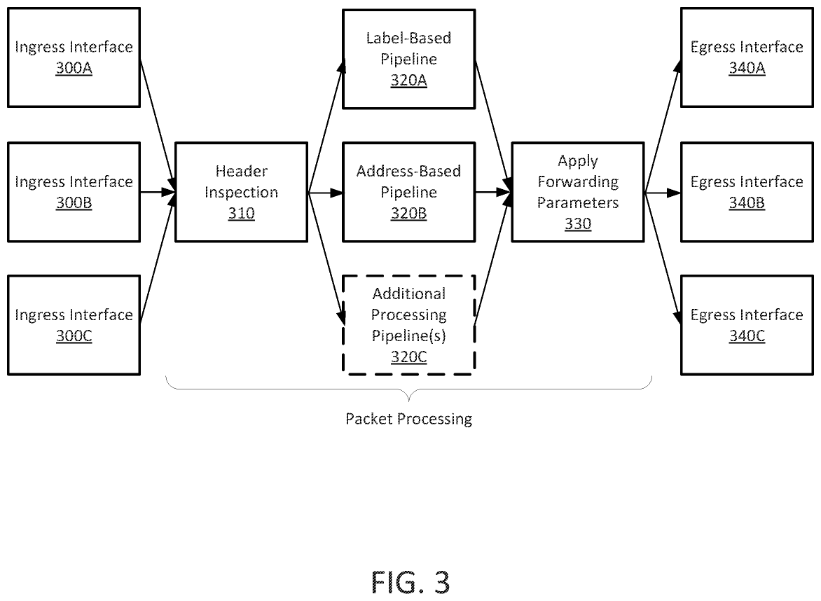

Forwarding table 240 is thus used herein to generally describe the information that may be applied by the packet processor 220 in determining the forwarding parameters for handling a packet. The forwarding table 240 includes various types of information according to particular types of packets and/or packet headers received by the networking device 200. Illustrated in FIG. 2 is a label table and an address table, although additional types of information for forwarding the packets may be included in additional configurations and may relate to different types of headers and/or forwarding parameters that may be used in different embodiments. In this example, the label table includes entries based on a label look up, and the address table includes entries based on addresses (e.g., destination IP addresses). In addition, particular forwarding parameters may be associated with different individual entries or tables in the forwarding table 240. As such, although a label table and address table are shown in FIG. 2, in some embodiments the particular tables accessed used for label-based routing and address-based routing may include tables in common to both types. For example, the label table and address table may determine a particular nexthop device based on the respective label or address information, and a joint table may be used for specifying the particular forwarding parameters for processing packets to reach various nexthop devices accessible from the networking device 200. As discussed further below with respect to FIGS. 3-5, the packet processor 220 may inspect headers of received packets, identify a relevant header for forwarding, and look up corresponding values in the forwarding table 240 to determine processing for the respective packets.

Together, the packet processor 220 and forwarding table 240 may be considered a “data plane” for processing packets by the networking devices. The respective components for the packet processor 220 and forwarding table 240 are often instantiated in hardware, such as application-specific integrated circuits (ASICS) to maximize throughput of the packets through the data plane.

A control plane controller 230 controls execution of the data plane, and may be responsible for modifying parameters or other configurations for the packet processor 220 and populating information in the forwarding table 240. The control plane controller 230 may also be responsible for updating the forwarding table 240, for example, by broadcasting information about addresses known to the networking device 200 or requesting information about unknown addresses. In some embodiments, the control plane controller 230 communicates with respective components of other networking devices to effectively learn network topology, implement labels, and implement other types of data control.

FIG. 3 shows an example of packet processing that may be applied by a packet processor, according to one embodiment. This processing may be performed, for example, by the packet processor 220 shown in FIG. 2. As discussed above with respect to FIG. 2, a packet is received at an interface, such as one of the ingress interfaces 300A-C and exits the networking device via one of the egress interfaces 340A-C.

Initially, the packet processor performs a header inspection 310 on the packet to determine the applicable headers in the packet and identify a forwarding header that determines the type of forwarding to be performed on the packet. The header inspection 310 may be considered a “pre-processing” step as the packet is inspected and may be routed for further lookups by the applicable processing pipeline. The portion of the networking device that performs this step may thus be considered a preprocessor and may be a portion of the packet processor. In some embodiments, the headers of the packet are ordered, such that the relevant header considered as the forwarding header is determined based on the order and/or type of the headers. In additional examples, the header to be considered as the forwarding header may be explicitly designated in the headers. In further examples, the headers may be nested, such that “outer” headers encapsulate “inner” headers, such that from the perspective of an outer header, the packet may include the outer header and a “payload” that includes the inner headers along with the relevant data payload.

After identifying the relevant forwarding header, the packet may be transferred to a packet processing pipeline based on the type of the forwarding header. For example, when the forwarding header includes a label, then the packet is sent to a label-based pipeline 320A. Likewise, when the forwarding header specifies a destination address (e.g., an Internet Protocol address in the forwarding header) then the packet is sent to an address-based pipeline 320B. Additional header types may also be used in different embodiments corresponding to additional processing pipelines 320C.

The different processing pipelines 320 may generally have a different number of stages, table lookups, and other processing steps to appropriately handle the relevant type of forwarding header. In general, the respective pipelines 320A-C use information in the relevant forwarding header to determine the forwarding parameters for the packet, which are then applied 330 before sending the packet to the specified egress interface 340A-C. The particular processing to be applied to the packets and the respective forwarding parameters may also differ for different processing pipelines 320. In addition, although shown as separate components in FIG. 3, in some embodiments, the respective processing pipelines 320 may include applying certain processing to a packet before subsequent stages that may be in common with other pipelines. For example, label-based processing may include rewriting or removing a label in a label header, while the address-based pipeline may include modifying characteristics of an address-based header. Although termed “pipelines,” the processing stages for different processing pipelines may merge or transition from one to another, such that each “pipeline” is not necessarily a parallel sequence of stages relative to one another compared to other of the processing pipelines. Rather, each pipeline may represent different initial steps for determining the forwarding parameters for a packet. For example, in various embodiments, when a label-based pipeline looks up a label for processing based on the label and the label is not found in the applicable label table, the packet may instead be transferred to the address-based pipeline to attempt forwarding by the address-based pipeline.

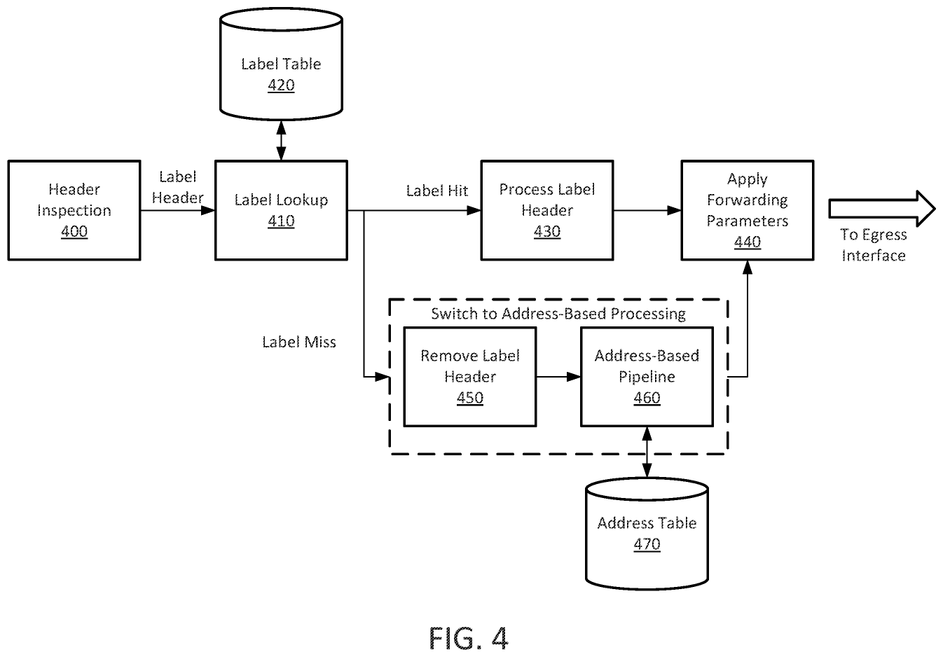

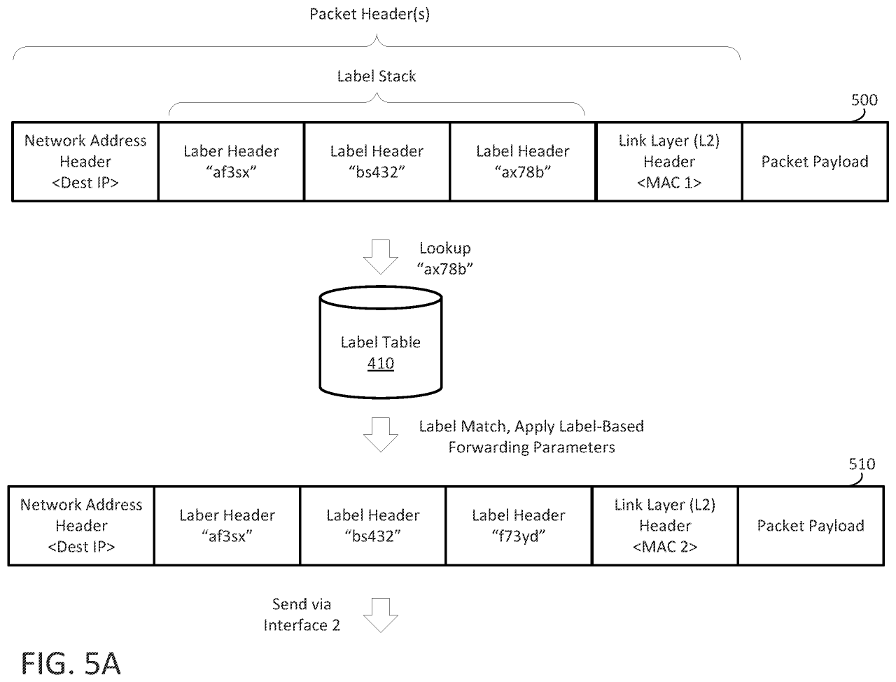

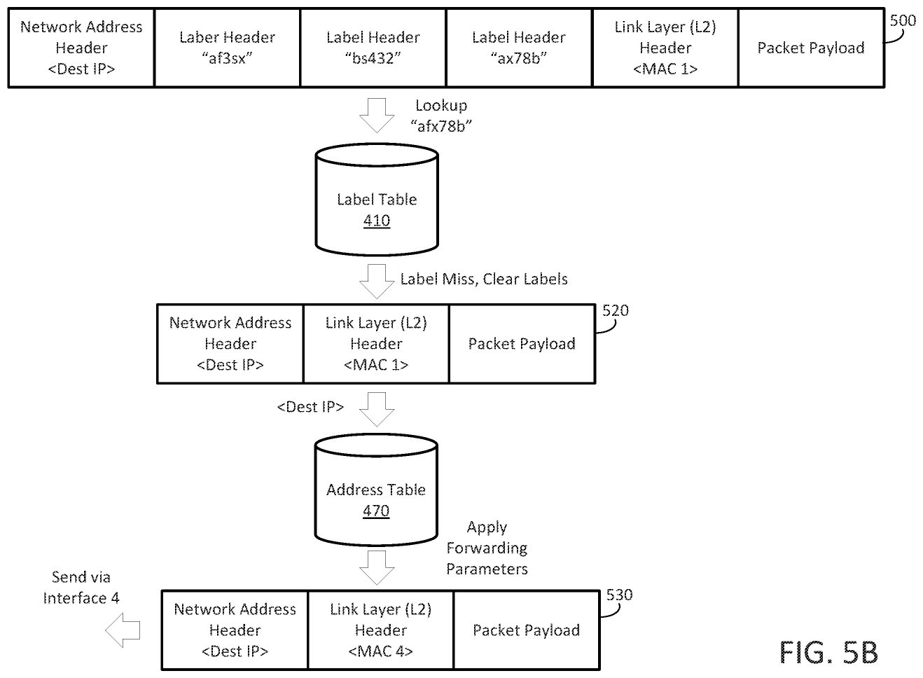

FIGS. 4 and 5A-B show an example of label-based processing with backup address-based processing, according to one embodiment. The label-based processing shown in FIG. 4 may begin with header inspection 400 as discussed above in FIG. 3. An example packet with related processing is shown and discussed in FIGS. 5A-B below, illustrating example processing of the packet when a corresponding label entry is in the label table and when it is missing. When the label header is identified as the relevant forwarding header, the packet is processed with the label-based pipeline by a label lookup 410 in a label table 420. When the paths associated with the label are installed in the networking device, the label lookup 410 in the label table 420 results in a “hit” in which a matching entry for the label is found in the label table 420. The matching entry in the label table 420 includes forwarding parameters and relevant configuration data for processing the packet. The pipeline may then include a stage to process the label header 430 according to the retrieved information from the label table 420. For example, the label header may be rewritten, or a label header may be removed (e.g., from a label stack) or otherwise modified, for example, to re-label the packet with a label corresponding to a label for the subsequent networking device. The packet may then be sent to a stage for applying 440 additional forwarding parameters, such as rewriting link layer (also termed L2 or MAC addresses) header information for the subsequent networking device. The packet may then be sent to the specified egress interface for transmission to the next networking device. As noted above, the label entry may include references to additional tables or processing stages, rather than directly including all relevant information for processing. When the forwarding header of the packet specifies a label, a matching entry in the label table 420 thus provides the relevant rule for processing the packet (e.g., providing the forwarding parameters or specifying the additional table lookups for determining the packet processing).

However, when the label is not available, the networking device may attempt to process the packet by switching to address-based processing of the packet. Although the label on the incoming packet typically means that the packet is designated for a specific path or specific type of handling according to an intended entry in the label table, switching to address-based processing may enable the packet to reach its destination rather than discarding the packet because the networking device lacks the label entry. When the label specified in the packet does not have a corresponding entry in the label table 420 (i.e., a lookup “miss” for the label table), the packet may then be switched from the label-based pipeline to an address-based pipeline 460.

However, the packet may still include one or more labels (e.g., in a label stack), such that forwarding the packet as-is (with label headers) may interfere with subsequent processing of the packet, if the packet is labeled for subsequent label-based processing. That is, the packet as received by the networking device included a label that designated processing by the networking device according to a corresponding rule in an entry of the label table. Because that entry is not available, the networking device may no longer be applying the intended processing to the packet, such that processing by subsequent devices may be unable to continue intended processing. As noted above, as a label entry may include information for modifying the label header, when that entry is missing the intended modification of the label header, it cannot be performed by the networking device, such that the label header may not have “expected” modifications from the perspective of the “circuit” represented by the labeled path as a whole (i.e., the sequence of label-based switching across the network). As such, to transition the packet to address-based processing, the label headers may be removed 450 to change subsequent forwarding of the packet by other devices to continue address-based forwarding (although subsequent devices, depending on their configuration, may subsequently re-initiate label-based processing). As necessary, the packet headers may also be modified to designate an address-based header as the forwarding header for the packet.

The address-based pipeline 460 may then process the packet based on a network address header, as though the packet had not been received with a label header. For example, the packet may be processed as though the header inspection of FIG. 3 had identified the network address header as the forwarding header. The address-based pipeline 460 may then process the packet, for example, by a lookup of a corresponding entry in an address table 470 based on a destination address of the network address header. When the address is not available in the address table, the networking device may drop the packet or attempt address resolution of the address and determine respective forwarding parameters. The relevant forwarding parameters may thus be determined and applied to attempt to process the packet according to the address information in the packet header.

FIGS. 5A-B show example packet processing of a packet with a label header, according to one embodiment. FIG. 5A illustrates an example of processing when the label is present in a label table 410, and FIG. 5B illustrates an example of processing when the label is not present in the label table 410. Initially, a packet 500 is received that includes a packet payload along with a number of packet headers. In this example, the packet headers include a link layer header, a number of labels in label headers forming a “label stack” and a network address header. The particular data in each header is shown in this example for illustration; particular header protocols may include additional information according to particular formatting structures for the respective headers and header protocols. In addition, packets may include alternative or different headers than shown in this example. For example, in this example multiple label headers are included as a “label stack.” In other embodiments, multiple labels may be included in a single label header.

The link layer header in this example specifies a destination link layer address, such as a MAC address of the networking device to receive the transmitted packet, here shown as “MAC 1” corresponding to a MAC address of the networking device. The label stack includes a number of labels to be used to direct the packet on the network, and may be relabeled, added to or removed, based on entries in the label table 410. In this example, the packet headers are inspected to identify the label stack and that the “top” label header (with label “ax78b”) is the relevant forwarding header for the packet. The packet 500 may then be processed with the label pipeline by looking up the associated label “ax78b” in the label table 410. In the example of FIG. 5A, the label “ax78b” has a corresponding entry in the label table 410 specifying a new label (“f73yd”) to be applied to the packet along with a link layer address (“MAC 2”) for a subsequent device and a designated interface for packet egress. After rewriting packet headers for packet 510, the packet 510 is then sent for egress via the designated interface 2.

FIG. 5B illustrates processing when the label lookup instead results in a miss, indicating that information for processing the packet is not stored in the networking device. Rather than discarding the packet 500, the packet is attempted to be forwarded based on the network address header. To do so, when the label lookup misses, the label headers may be removed to “convert” the packet 500 to packet 520 for address-based processing, such that the relevant forwarding header is the network address header. The packet 520 may then be processed based on the network address header by querying the address table 470 with the specified destination address (e.g., a destination IP address) to determine forwarding parameters. In this example, the retrieved forwarding parameters specify sending the packet via interface 4 with a destination MAC address of MAC 4. The link layer header is then rewritten to specify MAC 4 in a rewritten packet 530 that may then be sent for egress via Interface 4. In additional examples, the forwarding parameters may specify the addition of additional labels, other encapsulations, and other types of processing.

In some instances, the packet headers may include multiple network address headers and other types of forwarding headers. The network address header designated as the forwarding header may be determined based on the order of the headers or respective encapsulations. For example, the next or “outermost” network address header may be used to provide the address used for forwarding the packet.

As such, although a packet may arrive with a label header indicating an “intended” circuit for the packet, when a networking device lacks an entry specifying the processing for that label, the networking device may nonetheless process the packet when the packet includes a network address header for the networking device to use address-based processing as an alternative. By removing the header labels from the packet, the packet is effectively changed to an address-based packet, which may effectively exit the “circuit” defined by the label-based path (and may do so “prematurely” relative to the intended end of the label-switched path across the network), enabling further devices to also process the packet with network address information and preventing potential conflicts with erroneous label headers.

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments of the invention may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A networking device comprising:
a set of interfaces for sending and receiving packets; and
a packet processor configured to:
determine a forwarding header for a packet, received by an ingress interface of the set of interfaces, the forwarding header including a label header specifying a packet label for forwarding the received packet;
look up the label header in a label table to determine whether the packet label has a matching label entry or has no matching label entry;
when the packet label has a matching label entry, forwarding the packet for egress via the set of interfaces according to the matching label entry; and
when the packet label has no matching label entry, identifying a destination address in another header of the received packet and forwarding the packet for egress via the set of interfaces according to the destination address.

2. The networking device of claim 1, wherein the packet processor is further configured to, when the packet label has no matching label entry, remove label-based headers from the received packet.

3. The networking device of claim 1, wherein the destination address is an Internet Protocol (IP) address.

4. The networking device of claim 1, wherein forwarding the packet for egress via the set of interfaces according to the destination address includes looking up a matching address entry in an address table and forwarding the packet according to the matching address entry.

5. The networking device of claim 1, wherein the packet processor is further configured, when the packet label has no matching label entry, to lookup the destination address in an address table and discard the received packet when the destination address has no matching address entry in the address table.

6. The networking device of claim 1, the packet processor being further configured to:
identify a plurality of headers in the received packet, including the label header and the address header; and
when the packet label has no matching label entry, specifying the address header as the forwarding header for the received packet.

7. The networking device of claim 1, wherein the label header is a Multi-Protocol Label Switching (MPLS) header.

8. A method for processing packets at a networking device, comprising:
receiving a packet at an ingress interface of the networking device;
determining a forwarding header in the packet that includes a label header specifying a packet label for forwarding the received packet;
determining that the packet label has no matching label entry in a label table; and
after determining that the packet label has no matching label entry, identifying a destination address in an address header of the received packet and forwarding the packet for egress from the networking device according to the destination address.

9. The method of claim 8, the method further comprising, when the packet label has no matching label entry, removing label-based headers from the received packet.

10. The method of claim 8, wherein the destination address is an Internet Protocol (IP) address.

11. The method of claim 8, wherein forwarding the packet for egress according to the destination address includes looking up a matching address entry in an address table and forwarding the packet according to the matching address entry.

12. The method of claim 8, the method further comprising, when the packet label has no matching label entry, looking up the destination address in an address table and discarding the received packet when the destination address has no matching address entry in the address table.

13. The method of claim 8, the method further comprising:
identifying a plurality of headers in the received packet, including the label header and the address header; and
when the packet label has no matching label entry, specifying the address header as the forwarding header for the received packet.

14. The method of claim 8, wherein the label header is a Multi-Protocol Label Switching (MPLS) header.

15. A networking device comprising:
a set of interfaces for sending and receiving packets;
a preprocessor configured to identify a forwarding header of a received packet at the set of interfaces and send the received packet for processing by one of a plurality of packet forwarding pipelines based on a type of the forwarding header;
a label-based pipeline that processes packets having a forwarding header specifying label forwarding; and
an address-based pipeline that processes packets having a forwarding header specifying address forwarding;
wherein the label-based pipeline is configured to look up a header label specified in the forwarding header of the received packet to identify a matching label entry in a label table and when no matching label entry is identified, transferring the received packet for processing by the address-based pipeline based on a destination address in the received packet.

16. The networking device of claim 15, wherein the label-based pipeline is further configured to, when the packet label has no matching label entry, remove label-based headers from the received packet.

17. The networking device of claim 15, wherein the address-based pipeline processes destination address is an Internet Protocol (IP) address.

18. The networking device of claim 15, wherein the label header is a Multi-Protocol Label Switching (MPLS) header.

19. The networking device of claim 15, wherein the label table includes entries specifying labels associated packet processing parameters for processing packets having the associated label.

20. The networking device of claim 15, wherein the address-based pipeline processes packets by looking up the destination address with an address table that specifies packet processing parameters for the destination address.
